(19) United States
(12) Patent Application Publication
(10) Pub. No.: US 2018/0137228 A1
(43) Pub. Date: May 17, 2018

(54) SIMULATION ASSIST APPARATUS AND SIMULATION ASSIST METHOD

(71) Applicant: FUJITSU LIMITED, Kawasaki-shi (JP)

(72) Inventors: Manabu KANAYA, Yokohama (JP); Ryota Tanaka, Kawasaki (JP)

(73) Assignee: FUJITSU LIMITED, Kawasaki-shi (JP)

(21) Appl. No.: 15/801,358

(22) Filed: Nov. 2, 2017

(30) Foreign Application Priority Data
Nov. 14, 2016 (JP) 2016-221449

(51) Int. Cl. G06F 17/50

(52) U.S. Cl. CPC G06F 17/5036

(57) ABSTRACT

A simulation assist apparatus includes a memory, and a processor coupled to the memory and configured to acquire a first index value included in an analysis object by a first simulation technique, acquire a second index value, acquire a third index value being obtained by processing a specific element being not permitted to be processed by the first simulation technique, and the first element by a second simulation technique, acquire a fourth index value being obtained by the second simulation technique, calculate an influence degree of the specific element based on a division value being obtained by dividing the value of the second index by the third index value, and a difference between the third index value and the fourth index value, and calculate a fifth index value being estimated to be obtained by processing the first simulation technique, based on the first index value and the influence degree.

### CROSS-REFERENCE TO RELATED APPLICATION

This application is based upon and claims the benefit of priority of the prior Japanese Patent Application No. 2016-221449, filed on Nov. 14, 2016, the entire contents of which are incorporated herein by reference.

### FIELD

The embodiment discussed herein is related to a simulation assist apparatus and a simulation assist method.

### BACKGROUND

A simulation technique for an analysis object such as a printed circuit board is often executed in related art. Further, there are a plurality of simulation techniques and an input value of a certain element among a plurality of elements included in an analysis object is not permitted to be inputted, in a certain simulation technique. As a relevant related art, there is such technique that a transmission line is analyzed based on an analysis result in a transmission line model in time domain, a result of time domain reflectometry (TDR) data obtained through SPICE analysis based on the transmission line model, and an impulse signal centering on a use frequency, for example.

Japanese Laid-open Patent Publication No. 2009-109345 is an example of related art.

### SUMMARY

According to an aspect of the invention, a simulation assist apparatus includes a memory, and a processor coupled to the memory and configured to acquire a first index value being obtained by processing first element among a plurality of elements included in an analysis object by a first simulation technique, acquire a second index value based on the first index value, acquire a third index value being obtained by processing a specific element being not permitted to be processed by the first simulation technique, and the first element among the plurality of elements, by a second simulation technique, acquire a fourth index value being obtained by processing the first element by the second simulation technique, calculate an influence degree of the specific element based on a division value being obtained by dividing the value of the second index by the value of the third index, and a difference value between the third index value and the fourth index value, and calculate a fifth index value being estimated to be obtained by processing the specific element by the first simulation technique, based on the first index value and the influence degree.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an operation example of a simulation assist apparatus according to an embodiment;

FIG. 2 is an explanatory diagram illustrating a configuration example of a simulation integration system;

FIG. 3 is an explanatory diagram illustrating a hardware configuration example of a PC;

FIG. 4 is an explanatory diagram illustrating a hardware configuration example of a simulation server;

FIG. 5 is an explanatory diagram illustrating a functional configuration example of the simulation integration system;

FIG. 6 is an explanatory diagram illustrating an example of a relationship among simulation techniques;

FIG. 7 is an explanatory diagram illustrating an example of a simulation element;

FIG. 8 is an explanatory diagram illustrating an example of a correlation between an analysis object and a simulation technique;

FIG. 9 is an explanatory diagram illustrating a sweep pattern generation example;

FIG. 10 is an explanatory diagram illustrating an example of a sweep pattern;

FIG. 11 is an explanatory diagram illustrating an example of an execution result of a simulation technique 1a;

FIG. 12 is an explanatory diagram illustrating an example of an execution result of a simulation technique 1b;

FIG. 13 is an explanatory diagram illustrating an example of an execution result of a simulation technique 2;

FIG. 14 is an explanatory diagram illustrating an integrated value of a sweep pattern whose difference with respect to an execution result of the simulation technique 2 is less than 1%;

FIG. 15 is a flowchart (I) illustrating an example of a sweep pattern generation processing procedure;

FIG. 16 is a flowchart (II) illustrating an example of the sweep pattern generation processing procedure;

FIG. 17 is a flowchart illustrating an example of a fitting processing procedure by the simulation technique 2;

FIG. 18 is a flowchart (I) illustrating an example of the fitting processing procedure by the simulation techniques 1a and 1b;

FIG. 19 is a flowchart (II) illustrating an example of the fitting processing procedure by the simulation techniques 1a and 1b;

FIG. 20 is a flowchart illustrating an example of a difference calculation processing procedure by the simulation technique 2;

FIG. 21 is a flowchart illustrating an example of a factor definition processing procedure; and

FIG. 22 is a flowchart illustrating an example of an actual simulation processing procedure.

### DESCRIPTION OF EMBODIMENT

In related art, accuracy in a result obtained through a certain simulation technique is sometimes insufficient. For example, in the case where there is an element which is not permitted to be inputted in a certain simulation technique among a plurality of elements included in an analysis object, the element which is not permitted to be inputted is not taken into account in a result obtained by the certain simulation technique. Thus, the result exhibits insufficient accuracy. Further, even if it is possible to input an element which is not permitted to be inputted in another simulation technique, a result obtained through the other simulation technique and a result obtained through the certain simulation technique are indices which are mutually different. Therefore, it is impossible to simply sum up the two results.

In an aspect, it is desirable to provide a simulation assist apparatus and a simulation assist method by which it is possible to improve accuracy in a result of a simulation.

A simulation assist apparatus, a simulation assist method, and a simulation assist program according to an embodiment which is disclosed will be detailed below with reference to the accompanying drawings.

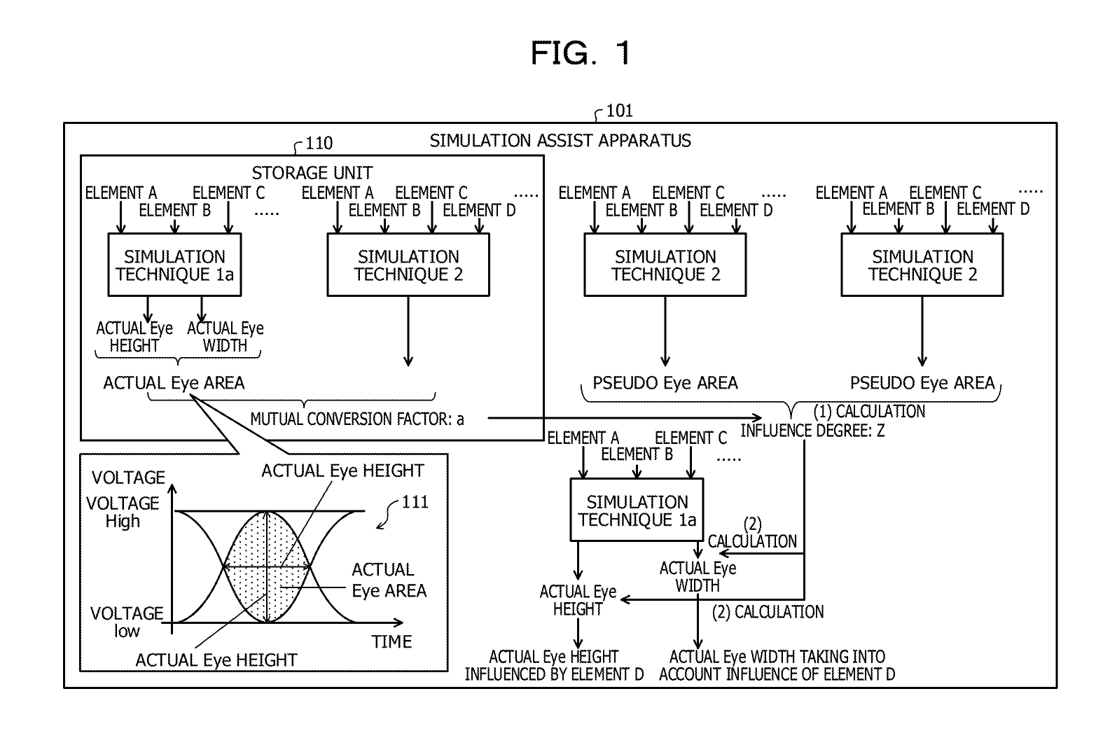

FIG. 1 is an explanatory diagram illustrating an operation example of a simulation assist apparatus 101 according to this embodiment. The simulation assist apparatus 101 is a computer which assists a simulation of an analysis object. The simulation assist apparatus 101 is a personal computer (PC), for example. The analysis object is a printed circuit board (PCB), for example.

Regarding designing of a PCB, especially regarding a high-frequency circuit, problems related to transmission often occur after manufacturing. Therefore, a simulation technique for transmission characteristics is executed before or after designing of a PCB, in most cases. Regarding the simulation technique, a simulation technique in time domain is executed with respect to a net list generated by connecting a plurality of models, by a tool such as a HSPICE, for example. Then, an obtained result is inputted into a margin evaluation tool provided by a vendor and is outputted as a final result of acceptance decision.

As an example of an acquisition method of a plurality of models, there is a method for acquiring circuit simulation models of a large scale integration (LSI)/integrated circuit (IC) vendor. Further, as another acquisition method, there is a method for acquiring input/output characteristic models used for simulation, from a mechanism vendor such as a connector. Furthermore, there is a method for acquiring models by generating wiring models (RLGC models) added with signal wiring or a layer structure of a PCB by a versatile tool. Here, RLGC represents resistance, inductance, conductance, and capacity. Further, there is a method for acquiring models by generating models of a via, lead-out wiring, or the like.

Further, there are electromagnetic field analysis which is executed by inputting three-dimensional structure data and frequency analysis using an S-parameter. In order to evaluate transmission characteristics, it is conceivable that several elements are individually analyzed by a plurality of simulation techniques and the whole judgement is made.

However, values respectively obtained by different simulation techniques are outputted in different indices, so that it is impossible to add up the values and estimate the final influence degree. For example, it is assumed that an analysis object is a certain interface device. A final target in evaluation of transmission characteristics of a certain interface device is to evaluate whether or not transmission characteristics reach an acceptance criterion value of transmission characteristics of the certain interface device, to verify a degree of risk, to judge necessity for improvement of layout designing, and the like. Accordingly, if an analysis result misses even only one element included therein, accuracy in simulation is degraded and thus, it is impossible to precisely make an acceptance decision. Here, examples of an element desired to be specifically analyzed include a wiring length, an impedance of wiring, an electromagnetic interference (EMI) noise received from a power source, material characteristics of a printed substrate, an output of a driver, a setting value of an equalizer, a three-dimensional influence of a wiring layer structure, and the like.

As described above, there are many elements desired to be specifically analyzed, but there are no simulation techniques for analyzing all of these elements at once. Therefore, in order to evaluate transmission characteristics of analysis object, elements are individually evaluated respectively by independent simulation techniques.

Therefore, this embodiment provides a description in which a value obtained through a technique, in which a certain element is not permitted to be inputted, is corrected based on a mutual conversion factor obtained through a simulation technique which bridges two simulation techniques.

An operation example of a simulation assist apparatus 101 will be described with reference to FIG. 1. In FIG. 1, the simulation assist apparatus 101 assists a first simulation technique and a second simulation technique. Hereinafter, the first simulation technique is referred to as a “simulation technique 1a” and the second simulation technique is referred to as a “simulation technique 2”. Here, a device different from the simulation assist apparatus 101 may execute the simulation techniques 1a and 2 or may execute either one simulation technique. Simultaneously, the simulation assist apparatus 101 may execute the simulation techniques 1a and 2.

The simulation technique 1a is a simulation technique in which an input value of any element among a plurality of elements included in an analysis object is permitted to be inputted and a value of a first characteristic is outputted. Here, elements included in an analysis object are referred to as “simulation elements”. In FIG. 1 or the following drawings, simulation elements may be described simply as “elements” so as to simplify the illustration. In the example of FIG. 1, simulation elements A to D are illustrated as a plurality of simulation elements. Further, it is assumed that the simulation technique 1a permits the simulation elements A to C to be inputted but does not permit the simulation element D to be inputted as a specific simulation element. Here, the simulation elements A to D are respectively a VIA length, a wiring length, a wiring impedance, and a reference layer shape, for example.

In the simulation technique 1a, a height and a width of an Eye pattern, for example, are outputted as values of the first characteristic. Further, the simulation assist apparatus 101 calculates an area of the Eye pattern, for example, as a value of the second characteristic based on the height and the width of the Eye pattern.

Here, the Eye pattern and the height, the width, and the area of the Eye pattern will be described with reference to a graph 111 illustrated in FIG. 1. The graph 111 is a graph illustrating a favorable Eye pattern. The horizontal axis of the graph 111 represents time and the vertical axis of the graph 111 represents a voltage. The Eye pattern is a pattern obtained such that signal waveforms are obtained by sampling the signal waveforms for a relatively long period of time and the obtained signal waveforms are displayed in an overlapped manner. An image obtained by the overlapping looks an eye, being called an Eye pattern. A shaded part in the graph 111 is the Eye part.

Hereinafter, a height of the Eye pattern is referred to as an “actual Eye height”, a width of the Eye pattern is referred to as an “actual Eye width”, and an area of the Eye pattern is referred to as an “actual Eye area”. When the Eye part is open, the transmission characteristics are good. When the Eye part is close, the transmission characteristics are poor. The state in which the Eye part is open represents that the actual Eye height and the actual Eye width have predetermined values or larger. Further, the shape of the Eye part approximates a rhomboid as illustrated by the shaded part in the graph 111, so that it is possible to obtain the Eye area by actual Eye height×actual Eye width/2.

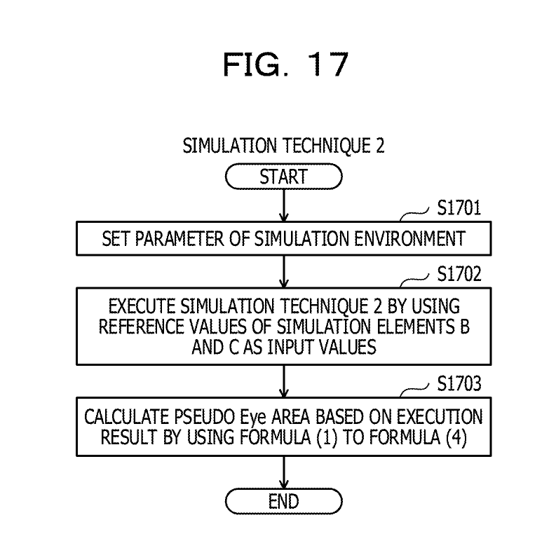

Further, the simulation technique 2 is a simulation which permits input of an input value of each of the simulation elements A to D and outputs an output value of a third characteristic. Here, the simulation element D is the specific element which is not permitted to be inputted in the simulation technique 1a among a plurality of simulation elements. Further, the third characteristic is a pseudo Eye area, for example. The pseudo Eye area is a pseudo Eye area obtained by excluding an influence of a noise from an Eye area in an ideal state of a signal. A specific calculation method of the pseudo Eye area will be illustrated in FIG. 17.

Thus, the simulation element D is not permitted to be inputted in the simulation technique 1a. On the other hand, the simulation element D is permitted to be inputted in the simulation technique 2, but it is impossible to judge transmission characteristics based on the pseudo Eye area obtained by the simulation technique 2. Therefore, it is aimed to obtain an actual Eye height and an actual Eye width which are influenced by an input value of the simulation element D in FIG. 1.

The simulation assist apparatus 101 is accessible to a storage unit 110. The storage unit 110 stores a value obtained by dividing an actual Eye area, which is obtained based on an actual Eye height and an actual Eye width which are obtained by the simulation technique 1a, by a pseudo Eye area which is a pseudo Eye area obtained by the simulation technique 2 and is an index identical to the actual Eye area. This value obtained by the division is a factor which enables mutual conversion of values obtained by the simulation technique 1a and the simulation technique 2, being referred to as a “mutual conversion factor a”. Further, the mutual conversion factor a represents a rate of an actual Eye area with respect to a pseudo Eye area, but a rate of a pseudo Eye area with respect to an actual Eye area may be obtained. Further, since the simulation element D is not inputted in the simulation technique 2, an influence of the simulation element D is not included in the mutual conversion factor a. FIG. 1 schematically illustrates that the simulation element D is not inputted in the simulation technique 2, by a dashed arrow.

Regarding a pseudo Eye area which is an index identical to an actual Eye area, it is possible for the simulation assist apparatus 101 to obtain a pseudo Eye area which is an index identical to an actual Eye area by using a third simulation technique, for example. Here, the third simulation technique is a simulation technique which bridges the simulation techniques 1a and 2 and is a simulation technique which permits simulation elements identical to those of the simulation technique 1a to be inputted and outputs a pseudo Eye area. The third simulation technique is referred to as a “simulation technique 1b”. The simulation assist apparatus 101 may execute the simulation technique 1b or another device may execute the simulation technique 1b.

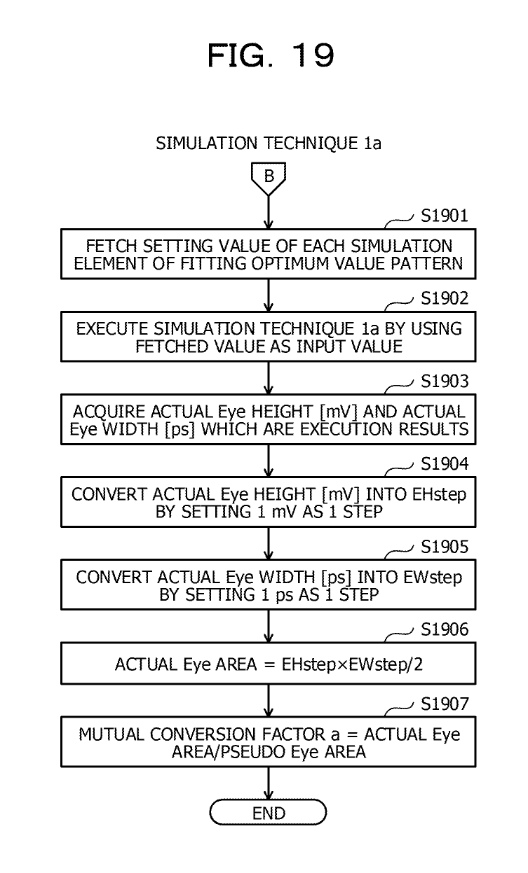

Specifically, the simulation assist apparatus 101 searches for an input value of the simulation technique 1b which enables obtainment of a pseudo Eye area whose difference with respect to a pseudo Eye area obtained in the simulation technique 2 is equal to or smaller than a predetermined value. Then, the simulation assist apparatus 101 inputs the searched input value into the simulation technique 1a so as to acquire an actual Eye area. Accordingly, the acquired actual Eye area and the pseudo Eye area are identical indices. A more specific calculation example of a mutual conversion factor will be described in FIG. 19 and the like.

Then, the simulation assist apparatus 101 acquires a pseudo Eye area obtained by inputting input values of the simulation elements A to C in the simulation technique 2 and a pseudo Eye area obtained by further inputting an input value of the simulation element D in the simulation technique 2. Subsequently, the simulation assist apparatus 101 calculates an influence degree Z of the input value of the simulation element D based on a difference between the two acquired pseudo Eye areas and a mutual conversion factor a, as illustrated by (1) in FIG. 1. For example, the simulation assist apparatus 101 calculates a value obtained by multiplying the above-mentioned difference by the mutual conversion factor a, as the influence degree Z. Further, if the mutual conversion factor a is a rate of a pseudo Eye area with respect to an actual Eye area, the simulation assist apparatus 101 may calculate a value obtained by dividing the above-mentioned difference by the mutual conversion factor a, as the influence degree Z. Here, since the above-mentioned difference represents an influence degree of the simulation element D in a pseudo Eye area, the influence degree Z obtained through multiplication of the mutual conversion factor a represents an influence degree of the simulation element D in an actual Eye area.

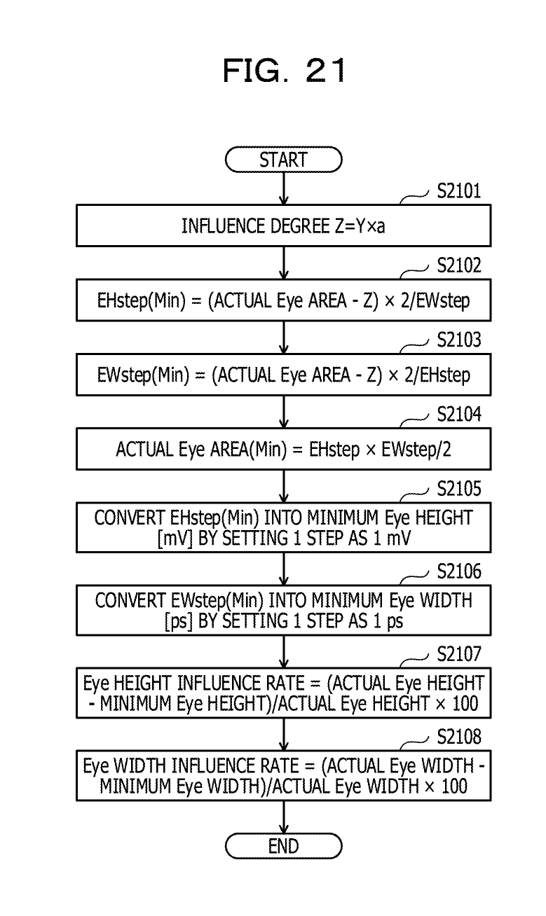

Subsequently, the simulation assist apparatus 101 acquires an actual Eye height and an actual Eye width which are obtained by inputting input values of the simulation elements A to C in the simulation technique 1a. The input values which are inputted here are values which are obtained after layout information of an analysis object is determined and whose accuracy is enhanced, for example. Then, the simulation assist apparatus 101 calculates an actual Eye height and an actual Eye width which are influenced by the simulation element D, based on the acquired actual Eye height and actual Eye width and the influence degree Z, as illustrated by (2) in FIG. 1. For example, the simulation assist apparatus 101 calculates the minimum Eye height and the minimum Eye width which are obtained in a state that an Eye part is influenced with the worst influence degree Z, that is, a state that both of an actual Eye height and an actual Eye width are smallest. Then, the simulation assist apparatus 101 calculates influence rates of the influence of the simulation element D with respect to a height and a width respectively based on the minimum Eye height and the minimum Eye width and multiplies the acquired actual Eye height and actual Eye width by the respective influence rates. A more specific calculation method will be illustrated in FIG. 21.

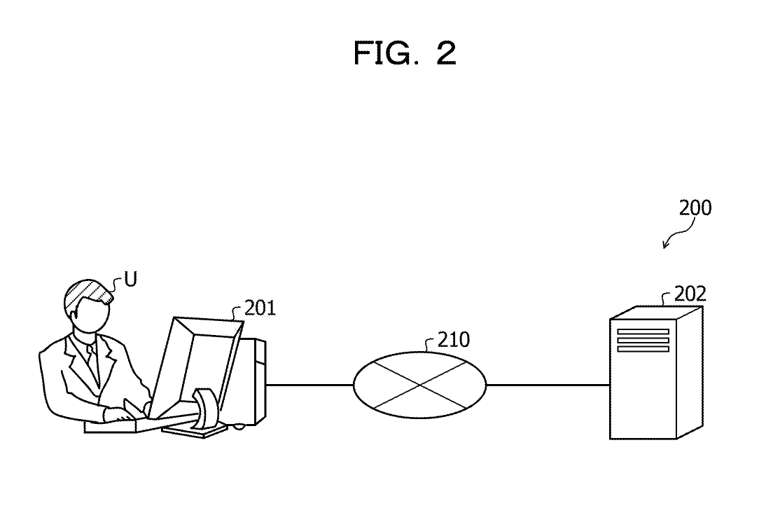

Then, the simulation assist apparatus 101 makes an acceptance decision by using the actual Eye height and the actual Eye width which are influenced by the simulation element D. Thus, it is possible for the simulation assist apparatus 101 to make an acceptance decision with higher accuracy. Subsequently, an example in which the simulation assist apparatus 101 is applied to a system will be described with reference to FIG. 2.

FIG. 2 is an explanatory diagram illustrating a configuration example of a simulation integration system 200. The simulation integration system 200 includes a PC 201 and a simulation server 202. The PC 201 and the simulation server 202 are connected via a network 210 such as the Internet, a local area network (LAN), and a wide area network (WAN). Here, the PC 201 corresponds to the simulation assist apparatus 101 illustrated in FIG. 1.

The PC 201 is a computer operated by a user U of the simulation integration system 200. Further, the PC 201 executes the simulation techniques 1a and 1b. The simulation server 202 is a computer which executes the simulation technique 2.

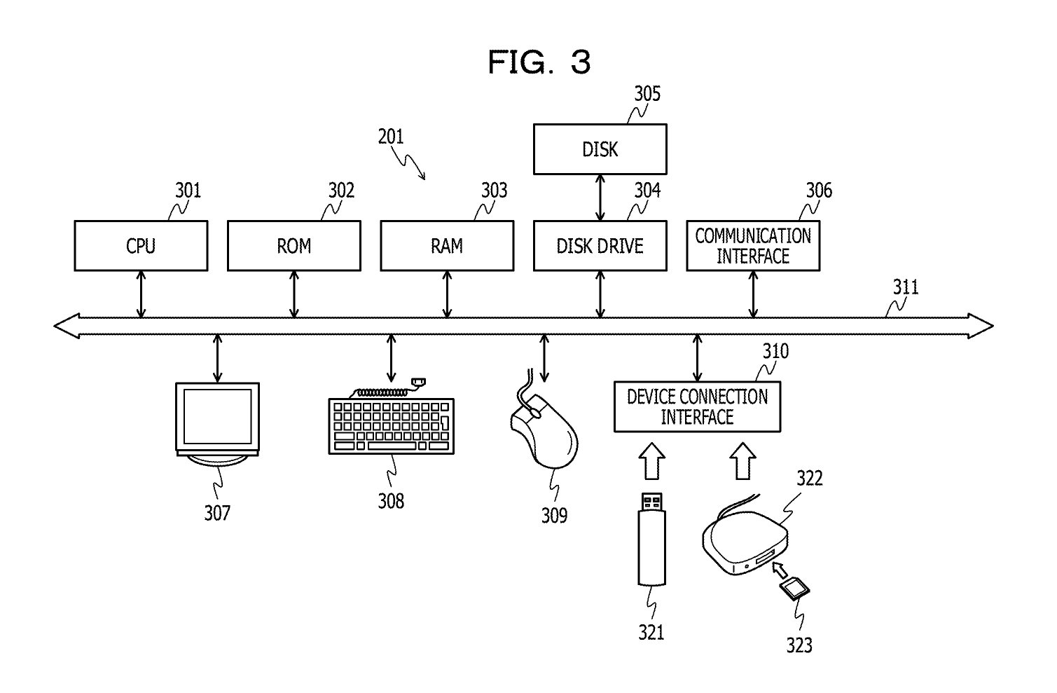

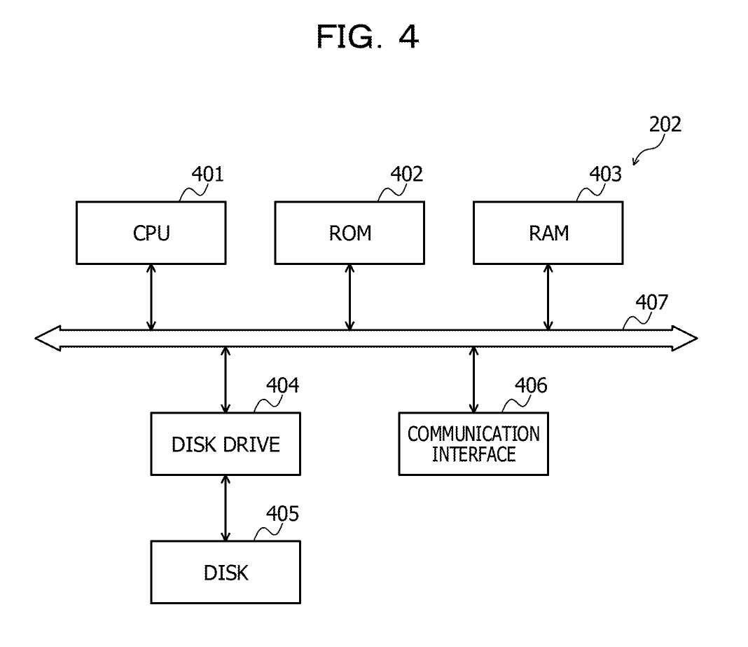

Subsequently, the hardware configuration of the PC 201 will be described with reference to FIG. 3 and the hardware configuration of the simulation server 202 will be described with reference to FIG. 4.

(Hardware Configuration of PC 201)

FIG. 3 is an explanatory diagram illustrating a hardware configuration example of the PC 201. The PC 201 includes a central processing unit (CPU) 301, a read-only memory (ROM) 302, a random access memory (RAM) 303, a disk drive 304, a disk 305, and a communication interface 306. The PC 201 further includes a display 307, a keyboard 308, a mouse 309, and a device connection interface 310. Further, the CPU 301, the ROM 302, the RAM 303, the disk drive 304, the communication interface 306, the display 307, the keyboard 308, the mouse 309, and the device connection interface 310 are mutually connected by a bus 311.

The CPU 301 is an arithmetic processing unit controlling the whole of the PC 201. The CPU 301 may be a multi-core processor having a plurality of cores. The ROM 302 is a non-volatile memory which stores a program such as a boot program. The RAM 303 is a volatile memory which is used as a work area of the CPU 301.

The disk drive 304 is a control device which controls reading and writing of data with respect to the disk 305 in accordance with the control of the CPU 301. As the disk drive 304, a magnetic disk drive, an optical disk drive, a solid state drive, or the like, for example, may be employed. The disk 305 is a non-volatile memory which stores data written under the control of the disk drive 304. In the case where the disk drive 304 is a magnetic disk drive, for example, a magnetic disk may be employed as the disk 305. Further, in the case where the disk drive 304 is an optical disk drive, an optical disk may be employed as the disk 305. Further, in the case where the disk drive 304 is a solid state drive, a semiconductor disk may be employed as the disk 305.

The communication interface 306 is a control device which serves as an interface between the network 210 and the inside and controls input and output of data in/from an external device. Specifically, the communication interface 306 is coupled to other devices via the network 210 through a communication channel. As the communication interface 306, a modem, a LAN adapter, or the like, for example, may be employed.

The display 307 is a device which displays not only a mouse cursor, an icon, and a toolbox, but also data including documents, images, and functional information. As the display 307, a cathode ray tube (CRT), a thin film transistor (TFT) liquid crystal display, a plasmatic display, or the like, for example, may be employed.

The keyboard 308 is a device which includes keys for inputting letters, digits, various types of instructions, and the like and is used for inputting data. Further, the keyboard 308 may be a touch-panel type input pad, a numeric keypad, or the like. The mouse 309 is a device for performing moving of a mouse cursor, range selection, moving of a window, change of the size of the window, and the like. The mouse 309 may be a trackball, a joystick, or the like as long as it similarly functions as a pointing device.

The device connection interface 310 is a control device which connects the PC 201 with peripheral devices and controls the connected peripheral devices. For example, a universal serial bus (USB) or the like may be employed as the device connection interface 310. Further, in the case where the device connection interface 310 is a USB, for example, a USB flash drive 321 or a memory card reader writer 322 may be connected to the device connection interface 310.

The USB flash drive 321 is a device which incorporates a flash memory, which is a non-volatile semiconductor memory and is capable of holding data without being supplied with power, therein and includes a drive device which performs control of a flash memory and communication with the device connection interface 310. The memory card reader writer 322 is a control device which controls reading and writing of data with respect to a memory card 323. The memory card 323 is a card type recording medium. In the memory card 323, a flash memory is incorporated.

(Hardware Configuration Example of Simulation Server 202)

FIG. 4 is an explanatory diagram illustrating a hardware configuration example of the simulation server 202. The simulation server 202 includes a CPU 401, a ROM 402, and a RAM 403. The simulation server 202 further includes a disk drive 404, a disk 405, and a communication interface 406. Further, the CPU 401, the ROM 402, the RAM 403, the disk drive 404, and the communication interface 406 are mutually connected by a bus 407.

The CPU 401 is an arithmetic processing unit controlling the whole of the simulation server 202. The ROM 402 is a non-volatile memory which stores a program such as a boot program. The RAM 403 is a volatile memory which is used as a work area of the CPU 401.

The disk drive 404 is a control device which controls reading and writing of data with respect to the disk 405 in accordance with the control of the CPU 401. As the disk drive 404, a magnetic disk drive, an optical disk drive, a solid state drive, or the like, for example, may be employed. The disk 405 is a non-volatile memory which stores data written under the control of the disk drive 404. In the case where the disk drive 404 is a magnetic disk drive, for example, a magnetic disk may be employed as the disk 405. Further, in the case where the disk drive 404 is an optical disk drive, an optical disk may be employed as the disk 405. Further, in the case where the disk drive 404 is a solid state drive, a semiconductor memory composed of a semiconductor element, that is, a so-called semiconductor disk may be employed as the disk 405.

The communication interface 406 is a control device which serves as an interface between the network 210 and the inside and controls input and output of data in/from other devices. Specifically, the communication interface 406 is coupled to other devices via the network 210 through a communication channel. As the communication interface 406, a modem, a LAN adapter, or the like, for example, may be employed.

(Functional Configuration Example of Simulation Integration System 200)

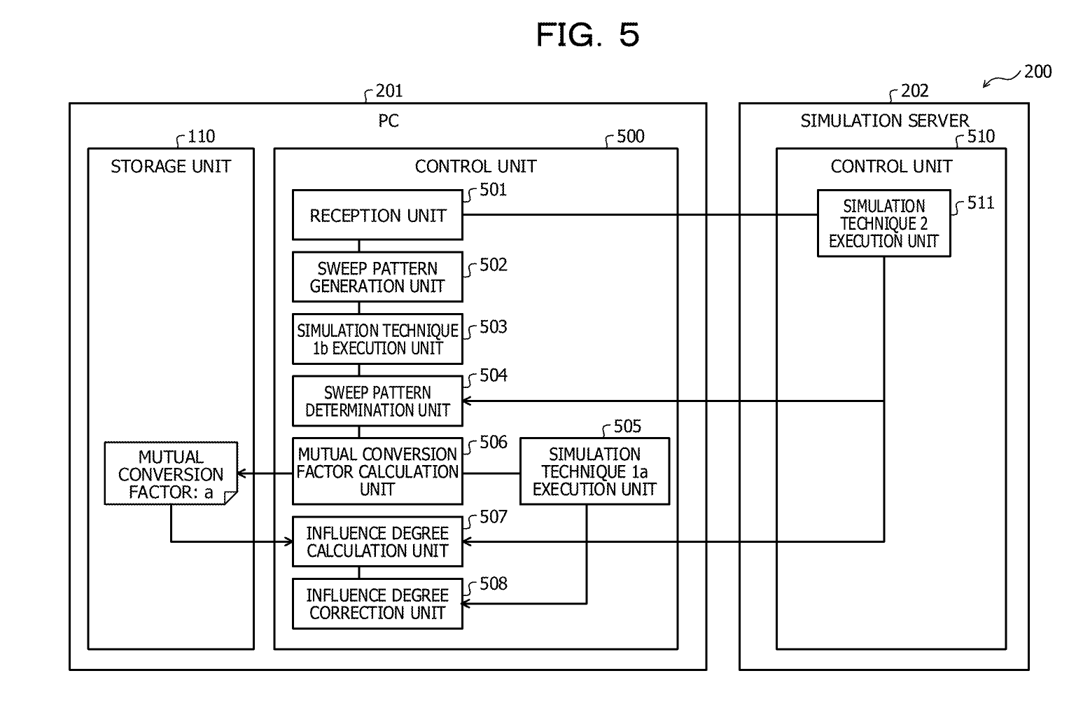

FIG. 5 is an explanatory diagram illustrating a functional configuration example of the simulation integration system 200. The PC 201 includes a control unit 500. The control unit 500 includes a reception unit 501, a sweep pattern generation unit 502, a simulation technique 1b execution unit 503, a sweep pattern determination unit 504, a simulation technique 1a execution unit 505, and a mutual conversion factor calculation unit 506. The control unit 500 further includes an influence degree calculation unit 507 and an influence degree correction unit 508. The control unit 500 realizes functions of respective units through execution of a program, which is stored in a storage device, by the CPU 301. The storage device is particularly the ROM 302, the RAM 303, or the disk 305, for example, illustrated in FIG. 3. Further, processing results of respective units are stored in the RAM 303, a register of the CPU 301, a cash memory of the CPU 301, or the like.

Further, the simulation assist apparatus 101 is accessible to the storage unit 110. The storage unit 110 is a storage device such as the RAM 303 and the disk 305. In the storage unit 110, a mutual conversion factor a is stored.

Further, the simulation server 202 includes a control unit 510. The control unit 510 includes a simulation technique 2 execution unit 511. The control unit 510 realizes functions of respective units through execution of a program, which is stored in a storage device, by the CPU 401. The storage device is particularly the ROM 402, the RAM 403, or the disk 405, for example, illustrated in FIG. 4. Further, processing results of respective units are stored in the RAM 403, a register of the CPU 401, a cash memory of the CPU 401, or the like.

The reception unit 501 receives a first input value of a simulation element which is permitted to be inputted in the simulation technique 1a, as any simulation element through an operation of the user U. In the case where there are a plurality of simulation elements which are permitted to be inputted in the simulation technique 1a, the number of first input values is plural as well.

The sweep pattern generation unit 502 generates a plurality of input values of the simulation elements which are permitted to be inputted in the simulation technique 1a, based on the received first input value. For example, the sweep pattern generation unit 502 generates a plurality of values which are obtained by increasing or decreasing the received first input value at random, as a plurality of input values.

Further, in the case where the number of first input values is plural, the sweep pattern generation unit 502 generates a plurality of input values based on each of the received first input values. In the following description, it is assumed that there are plurality of simulation elements which are permitted to be inputted in the simulation technique 1a, and a set of input values which are generated with respect to each of the simulation elements is referred to as a “sweep pattern”. For example, it is assumed that the reception unit 501 receives first input values of respective simulation elements A to C. In this case, the sweep pattern generation unit 502 generates a set of values which are obtained by increasing or decreasing the first input value of each of the simulation elements A to C at random, as a sweep pattern. Then, the sweep pattern generation unit 502 generates a plurality of such sweep patterns.

The simulation technique 1b execution unit 503 executes the simulation technique 1b. For example, the simulation technique 1b execution unit 503 inputs each input value of each of a plurality of sweep patterns generated by the sweep pattern generation unit 502 and outputs a pseudo Eye area of each of the sweep patterns.

The sweep pattern determination unit 504 determines a certain sweep pattern among a plurality of generated sweep patterns based on a difference between a pseudo Eye area obtained by inputting the first input value in the simulation technique 2 and a pseudo Eye area of each sweep pattern. Here, since a sweep pattern is a set of input values, the sweep pattern determination unit 504 determines a second input value among a plurality of input values in the case where the number of first input values is one. Here, a certain sweep pattern includes input values by which an actual Eye area which is an index identical to a pseudo Eye area obtained by the simulation technique 2, illustrated in FIG. 1, is obtained. Thus, values are matched (fitting) so as to obtain identical indices. Therefore, a certain sweep pattern is referred to as a “fitting optimum value pattern”.

Further, the sweep pattern determination unit 504 may determine a fitting optimum value pattern based on a difference between a pseudo Eye area and a pseudo Eye area of each sweep pattern and a difference between each input value of each sweep pattern and a received first input value. For example, it is assumed that there are two sweep patterns which exhibit approximately same levels of differences between a pseudo Eye area and a pseudo Eye area of each sweep pattern. In this case, the sweep pattern determination unit 504 determines a sweep pattern whose difference between each input value of the sweep pattern and a received input value is smaller between the above-mentioned sweep patterns, as a fitting optimum value pattern.

The simulation technique 1a execution unit 505 executes the simulation technique 1a. For example, the simulation technique 1a execution unit 505 inputs each input value of a fitting optimum value pattern so as to execute the simulation technique 1a and outputs an actual Eye height and an actual Eye width.

The mutual conversion factor calculation unit 506 calculates a mutual conversion factor a and stores the mutual conversion factor a in the storage unit 110. The mutual conversion factor a is a value obtained by dividing an actual Eye area based on an actual Eye height and an actual Eye width which are obtained by inputting a fitting optimum value pattern in the simulation technique 1a by a pseudo Eye area obtained by inputting the fitting optimum value pattern in the simulation technique 1b.

The simulation technique 2 execution unit 511 executes the simulation technique 2. For example, the simulation technique 2 execution unit 511 inputs input values of the simulation elements A to C in the simulation technique 2 so as to execute the simulation technique 2 and outputs a pseudo Eye area. Further, the simulation technique 2 execution unit 511 inputs the above-mentioned input values of the simulation elements A to C and input values of the simulation element D in the simulation technique 2 and outputs a pseudo Eye area.

The influence degree calculation unit 507 calculates an influence degree Z of the input values of the simulation element D based on a difference between the above-mentioned two pseudo Eye areas and the mutual conversion factor a.

The influence degree correction unit 508 acquires an actual Eye height and an actual Eye width obtained by inputting the input values of the simulation elements A to C in the simulation technique 1a. Then, the influence degree correction unit 508 corrects the acquired actual Eye height and actual Eye width so that an influence of the simulation element D is taken into account. Specifically, the influence degree correction unit 508 calculates an actual Eye height and an actual Eye width which are influenced by the simulation element D, based on the acquired actual Eye height and actual Eye width and the influence degree Z.

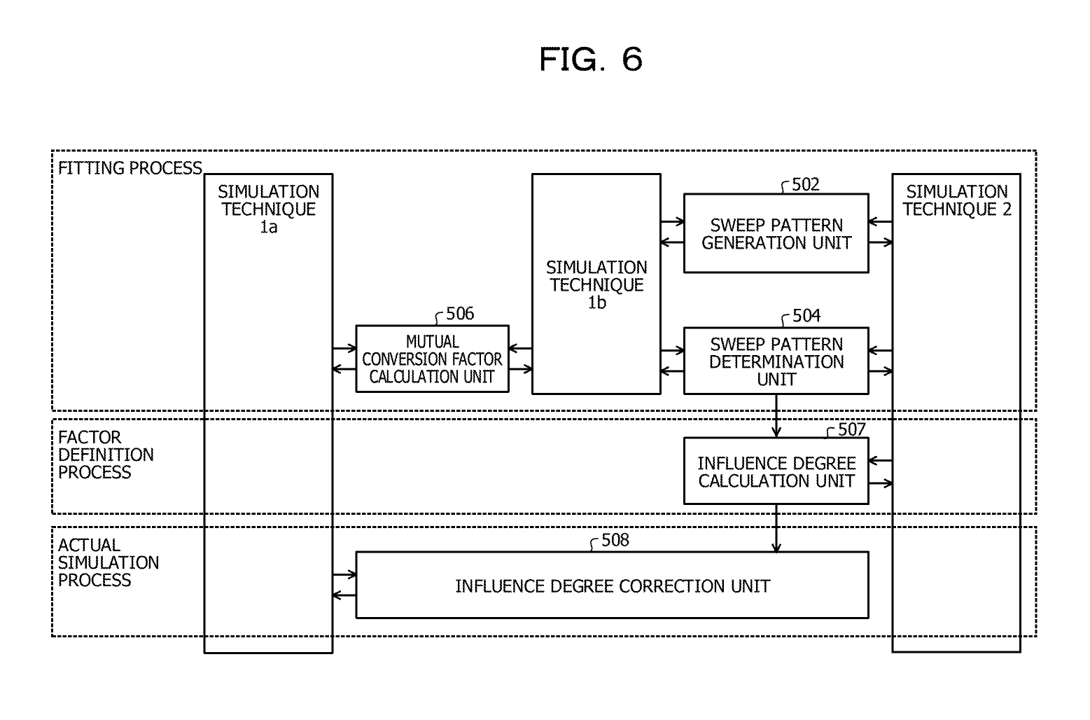

FIG. 6 is an explanatory diagram illustrating an example of a relationship among simulation techniques. FIG. 6 illustrates which process each functional unit illustrated in FIG. 5 belongs to when processing performed by the simulation integration system 200 is divided into three processes which are a fitting process, a factor definition process, and an actual simulation process.

The fitting process is a process which is performed until a fitting optimum value pattern is determined and includes the sweep pattern generation unit 502, the sweep pattern determination unit 504, and the mutual conversion factor calculation unit 506 in FIG. 6. The factor definition process is a process for obtaining the influence degree Z of the simulation element D due to addition of the simulation element D which is not permitted to be inputted in the simulation techniques 1a and 1b and includes the influence degree calculation unit 507. The actual simulation process is a process in which a final simulation is executed after designing of an analysis object is completed and layout information is determined and includes the influence degree correction unit 508.

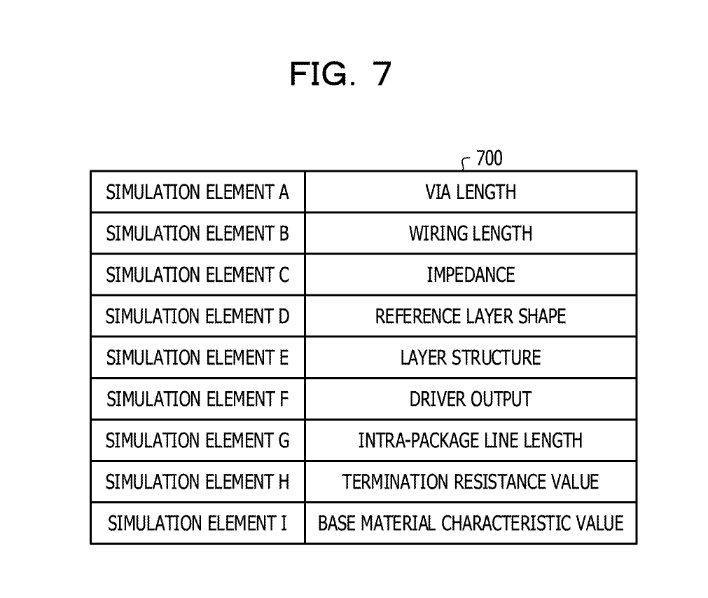

FIG. 7 is an explanatory diagram illustrating an example of a simulation element. The simulation element A is a VIA length. The simulation element B is a wiring length. The simulation element C is a wiring impedance. The simulation element D is a reference layer shape. The simulation element E is a layer structure. The simulation element F is a driver output. The simulation element G is an intra-package line length. The simulation element H is a termination resistance value. The simulation element I is a base material characteristic value.

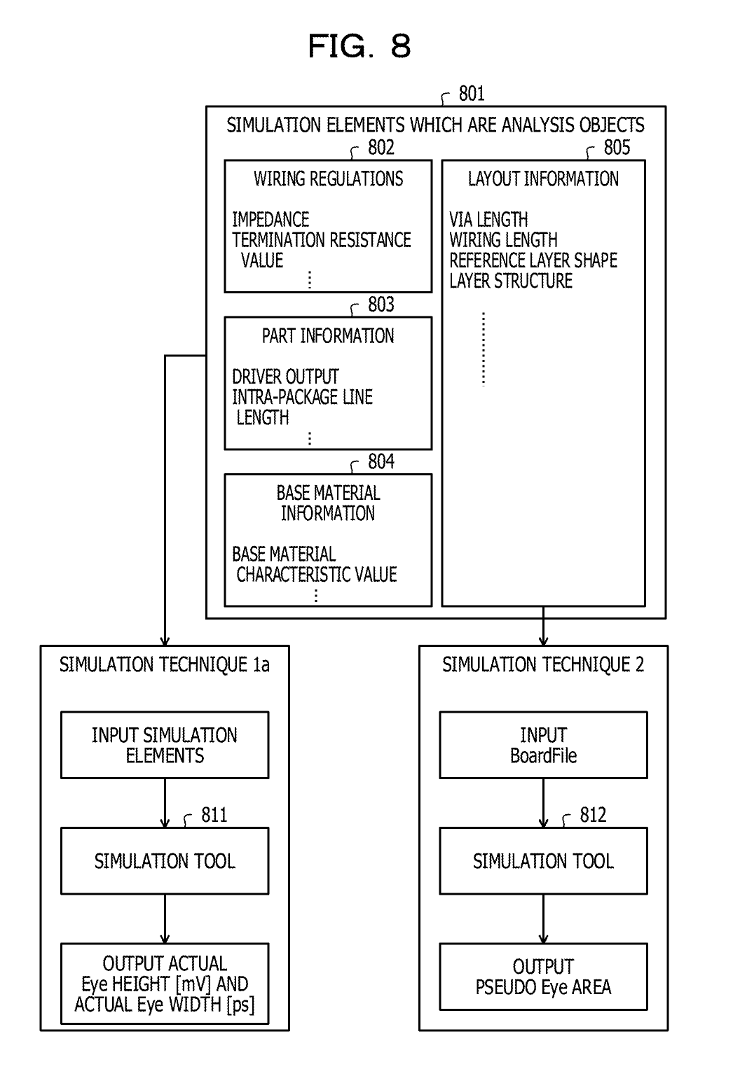

FIG. 8 is an explanatory diagram illustrating an example of a correlation between an analysis object and a simulation technique. FIG. 8 illustrates a relationship between a simulation element which is an analysis object and the simulation techniques 1a and 2. An analysis object list 801 illustrated in FIG. 8 is obtained by categorizing the simulation elements illustrated in FIG. 7. As wiring regulations 802, an impedance and a termination resistance value, for example, are included. Further, as part information 803, a driver output and an intra-package line length, for example, are included. Further, as base material information 804, a base material characteristic value, for example, is included. Further, as layout information 805, a VIA length, a wiring length, a reference layer shape, and a layer structure, for example, are included.

In the simulation technique 1a, information to be used in the simulation technique 1a are collected from the analysis object list 801 so as to construct a simulation environment. Then, as illustrated in the lower left of FIG. 8, the PC 201 inputs the simulation elements in a simulation tool 811 so as to execute the simulation technique 1a and outputs an actual Eye height [mV] and an actual Eye width [ps] as execution results.

Further, the PC 201 outputs BoardFile from the layout information 805 and transmits the BoardFile to the simulation server 202. The simulation server 202 which has received the BoardFile inputs the BoardFile into a simulation tool 812 so as to execute the simulation technique 2 and outputs a pseudo Eye area as an execution result.

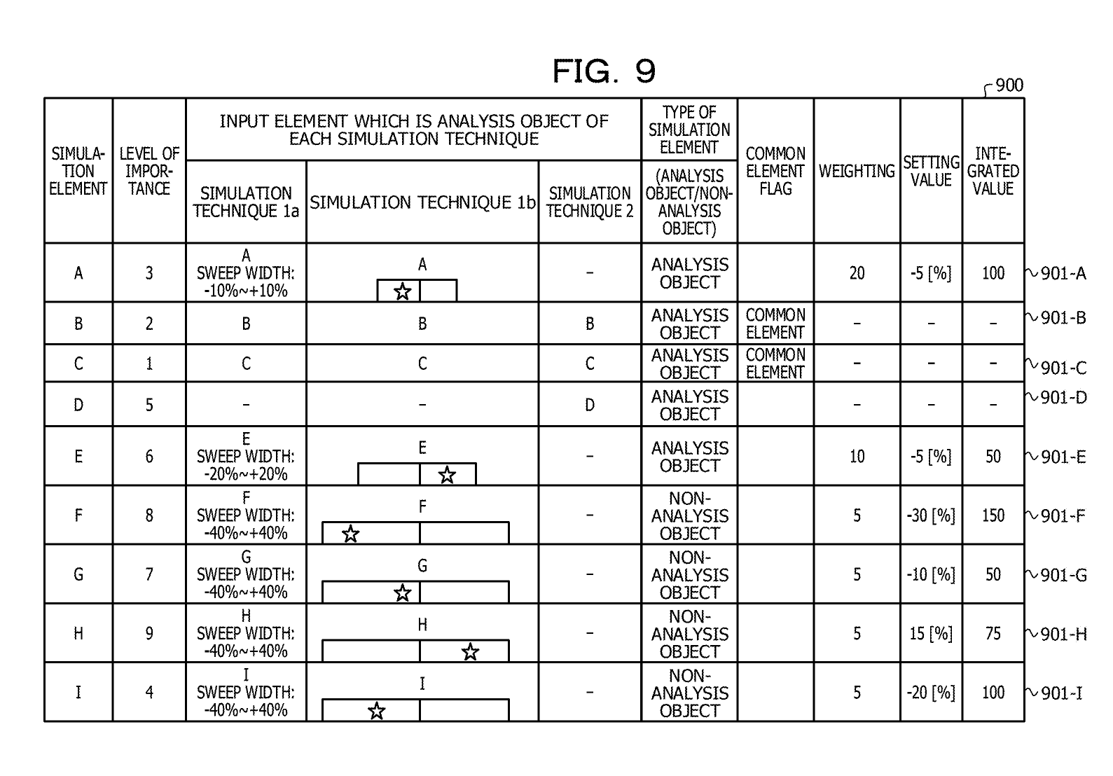

FIG. 9 is an explanatory diagram illustrating a sweep pattern generation example. A table 900 illustrated in FIG. 9 lists input values inputted by the user U and output values outputted by the PC 201 when the sweep pattern generation processing is executed. The PC 201 stores input values inputted by the user U and output values outputted by the PC 201 in a form of the table 900, for example. The table 900 illustrated in FIG. 9 includes records 901-A to 901-I.

The table 900 includes items which are simulation element, level of importance, relationship of input element which is analysis object of each simulation technique, type of simulation element, common element flag, weighting, setting value, and integrated value.

In the item of simulation element, a symbol denoting a simulation element is stored. In the item of level of importance, a value representing a level of importance inputted by the user U is stored. Regarding level of importance illustrated in FIG. 9, as a value is smaller, the level of importance is higher. In the item of input element which is analysis object of each simulation technique, a simulation element which is an analysis object in each simulation technique is stored. The item of input element is inputted by the user U as well. For a simulation element which is not an input object, “-” is stored.

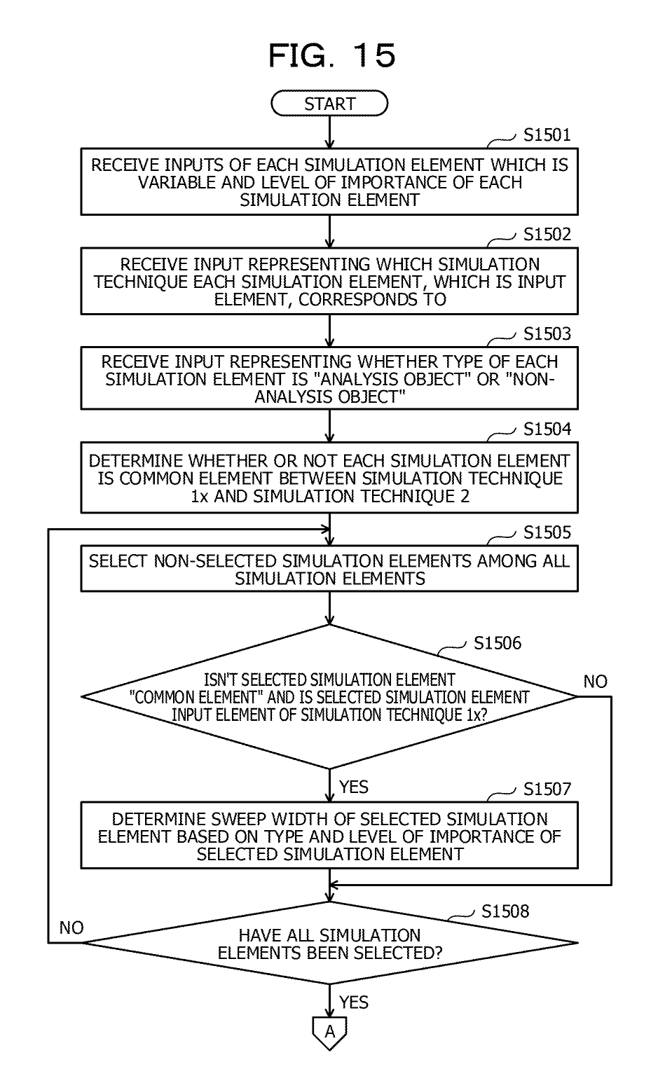

Further, in FIG. 9, a sweep width which is determined by the PC 201 is stored in the items of simulation techniques 1a and 1b. The sweep width is a range of a value to be permitted to be set. In this range, the value may be away from a reference value. Further, in the item of simulation technique 1b illustrated in FIG. 9, a sweep width is schematically illustrated by a width of a rectangle. Further, a vertical line in the rectangle represents a reference value and a position of a star represents a value in a certain sweep pattern. A specific method for determining a sweep pattern will be described in FIG. 15.

In the item of type of simulation element, a character string representing a type of a simulation element is stored. More specifically, in the item of type of simulation element, a character string representing whether a simulation element is an analysis object or a non-analysis object is stored. Here, a simulation element which is an analysis object is an element whose value may be changed by designing. On the other hand, a simulation element which is a non-analysis object is an element whose value may not be changed or whose value is not have to be changed. In the item of common element flag, a character string representing whether or not a simulation element is an element which is common to the simulation techniques 1a and 1b and the simulation technique 2 is stored. Specifically, in the case of a common element, a character string “common element” is stored in the item of common element flag.

In the item of weighting, a value which represents weighting and is determined by the PC 201 is stored. Specifically, the PC 201 determines a value which is in inverse proportion to amplitude of the sweep width, as a value of weighting. In the item of setting value, a setting value of a simulation element which is an object in a certain sweep pattern is stored. Here, a setting value is a value which is selected at random from a range of the sweep width. In the item of integrated value, an absolute value of a value obtained by multiplying weighting by a setting value is stored.

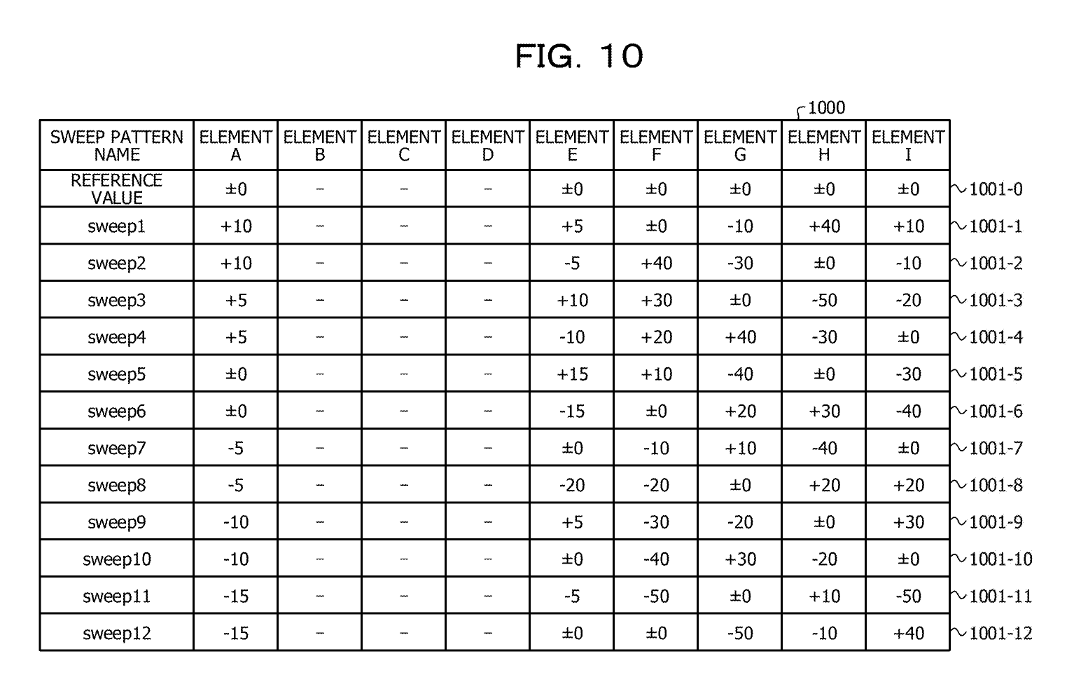

FIG. 10 is an explanatory diagram illustrating an example of a sweep pattern. A table 1000 illustrated in FIG. 10 represents a sweep pattern of a reference value and sweep patterns of sweep1 to sweep12 as generated sweep patterns. The table 1000 includes records 1001-0 to 1001-12. The record 1001-0 represents the sweep pattern of the reference value. Further, the records 1001-1 to 1001-12 represent sweep patterns of sweep1 to sweep12 respectively.

For example, the record 1001-1 represents that the simulation elements A and I are +10%, the simulation element E is +5%, the simulation element G is −10%, and the simulation element H is +40%, in the sweep pattern of sweep1. Here, +5% of a layer structure which is the simulation element E represents that the thickness of the layer structure is +5%, for example. In a similar manner, the case where a reference layer shape which is the simulation element D is +x % represents that the size of the reference layer shape is +x %, for example. In a similar manner, the case where a driver output which is the simulation element F is +x % represents that a driver output value is +x %, for example.

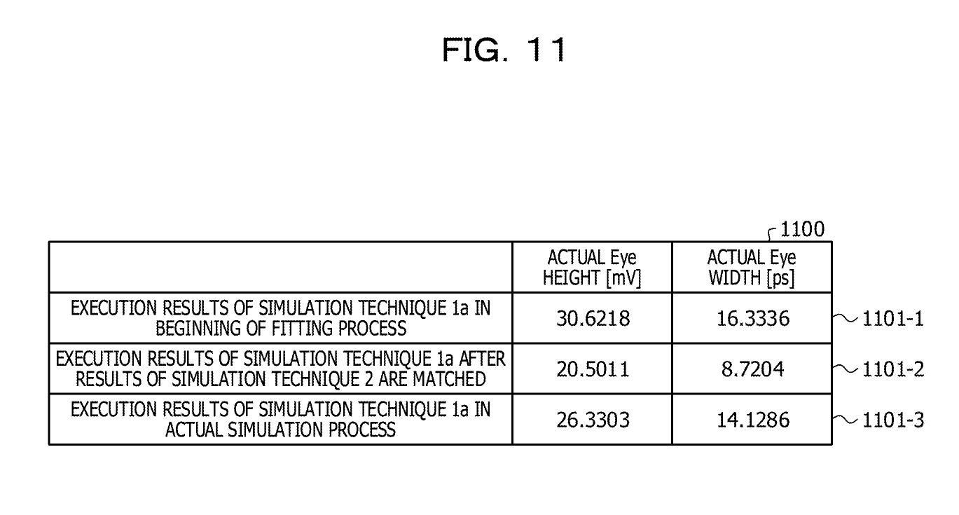

Subsequently, execution results of the simulation techniques 1a, 1b, and 2 will be described with reference to FIGS. 11 to 13. These values will be used in flowcharts illustrated in FIGS. 15 to 22.

FIG. 11 is an explanatory diagram illustrating an example of an execution result of the simulation technique 1a. A table 1100 illustrated in FIG. 11 lists execution results of the simulation technique 1a. The table 1100 illustrated in FIG. 11 includes records 1101-1 to 1101-3.

The record 1101-1 represents an actual Eye width and an actual Eye height which are execution results of the simulation technique 1a in the beginning of the fitting process. Further, the record 1101-2 represents an actual Eye width and an actual Eye height which are execution results of the simulation technique 1a after results of the simulation technique 2 are matched. Further, the record 1101-3 represents an actual Eye width and an actual Eye height which are execution results of the simulation technique 1a in the actual simulation process.

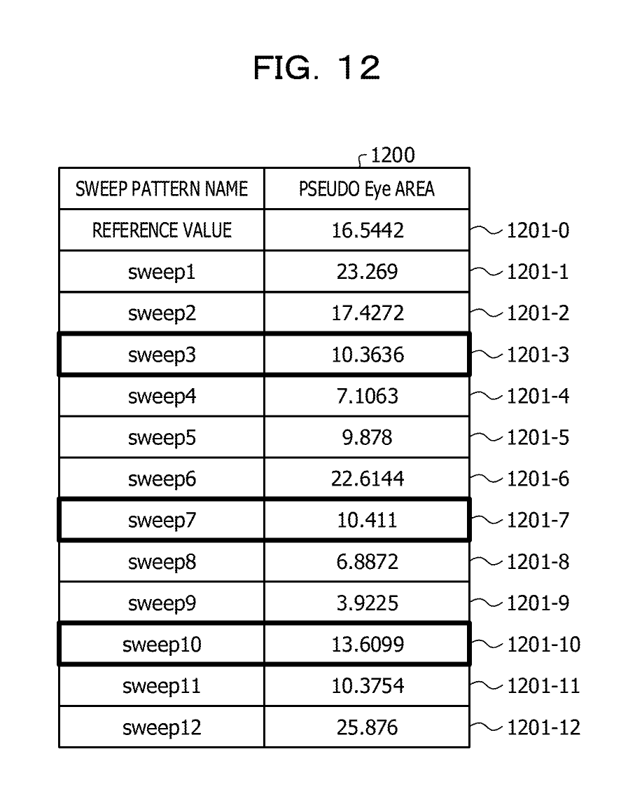

FIG. 12 is an explanatory diagram illustrating an example of an execution result of the simulation technique 1b. A table 1200 illustrated in FIG. 12 lists pseudo Eye areas which are execution results of the simulation technique 1b with respect to a sweep pattern of the reference value and sweep patterns of sweep1 to sweep12 as generated sweep patterns, respectively.

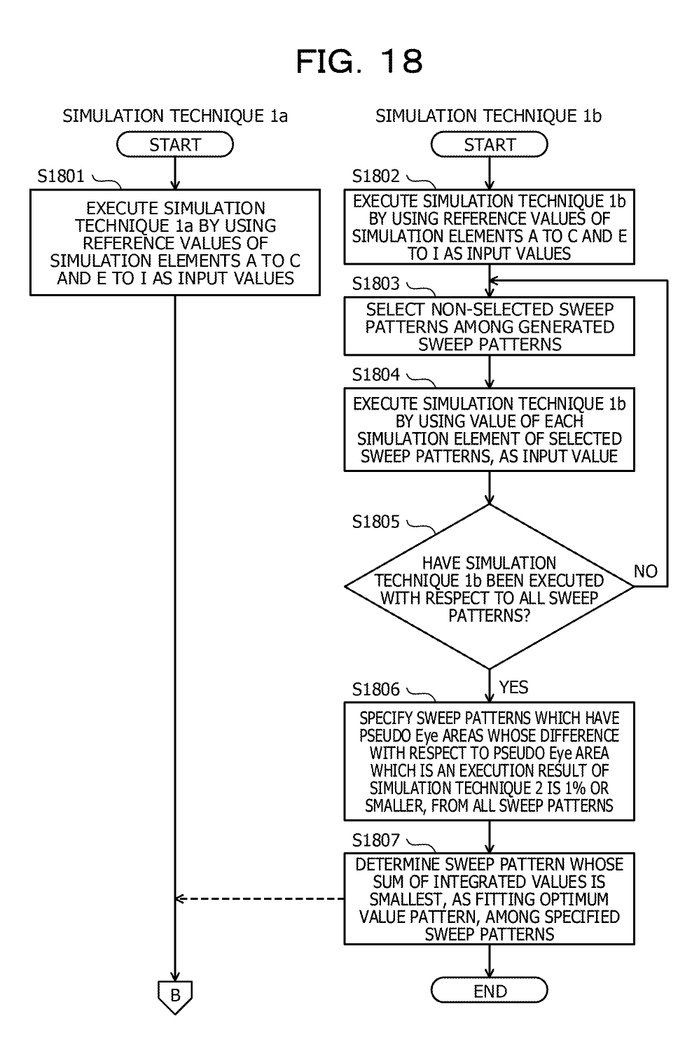

Here, in FIG. 12, the sweep patterns of sweep3, sweep7, and sweep10 are surrounded by thick frames. These sweep patterns of sweep3, sweep7, and sweep10 which are surrounded by thick frames represent sweep patterns whose difference with respect to an execution result of the simulation technique 2 in the fitting process is less than 1%. More detailed description will be provided in FIG. 18.

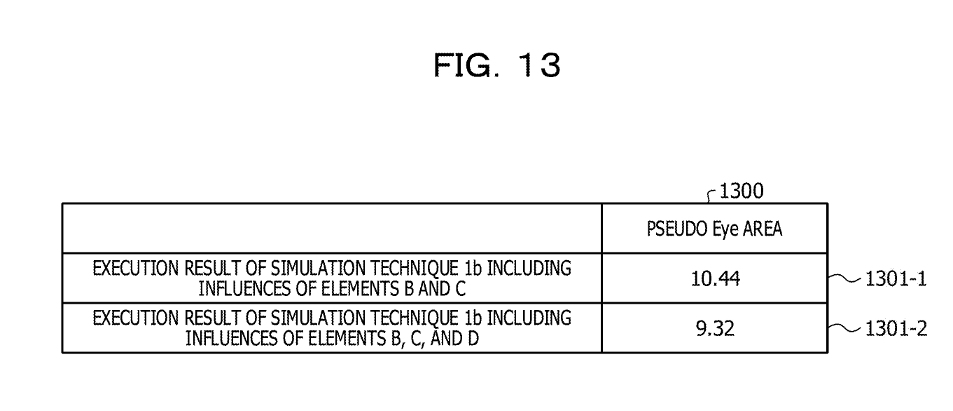

FIG. 13 is an explanatory diagram illustrating an example of an execution result of the simulation technique 2. A table 1300 illustrated in FIG. 13 lists execution results of the simulation technique 2. The table 1300 illustrated in FIG. 13 includes records 1301-1 and 1301-2.

The record 1301-1 represents a pseudo Eye area which is an execution result of the simulation technique 1b including influences of the elements B and C in the fitting process. Further, the record 1301-2 represents a pseudo Eye area which is an execution result of the simulation technique 1b including influences of the elements B, C, and D.

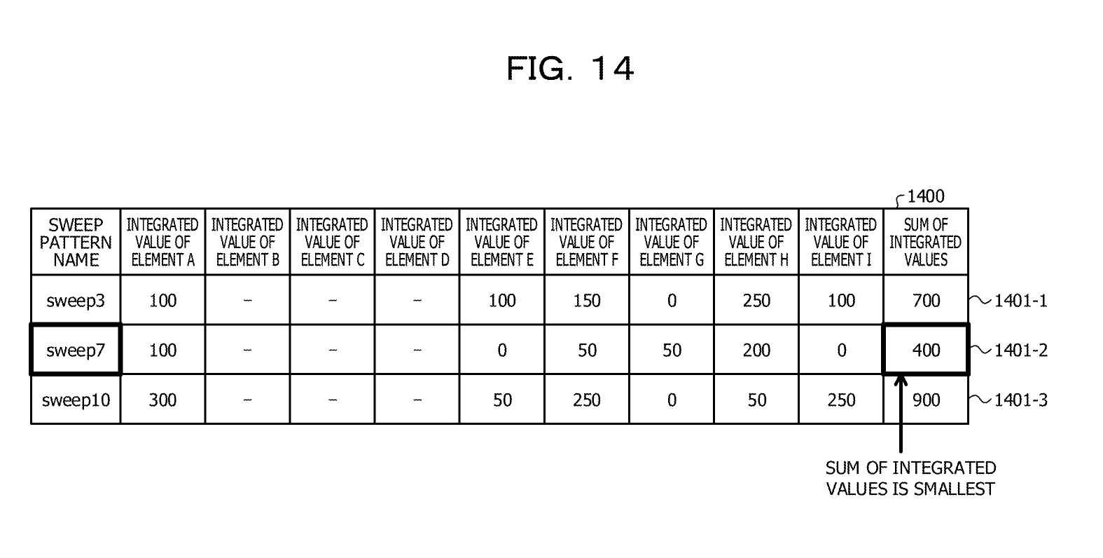

FIG. 14 is an explanatory diagram illustrating an integrated value of a sweep pattern whose difference with respect to an execution result of the simulation technique 2 is less than 1%. A table 1400 illustrated in FIG. 14 represents an integrated value of each simulation element of the sweep patterns sweep3, sweep7, and sweep10, whose difference with respect to an execution result of the simulation technique 2 is less than 1%, and a sum of integrated values of respective simulation elements.

Here, sweep7 and the sum of integrated values of sweep7 are surrounded by thick frames. This sweep7 surrounded by the thick frame is a pattern which is to be determined as a fitting optimum value pattern. More detailed description will be provided in FIG. 18.

Subsequently, flowcharts executed by the simulation integration system 200 will be described with reference to FIGS. 15 to 22.

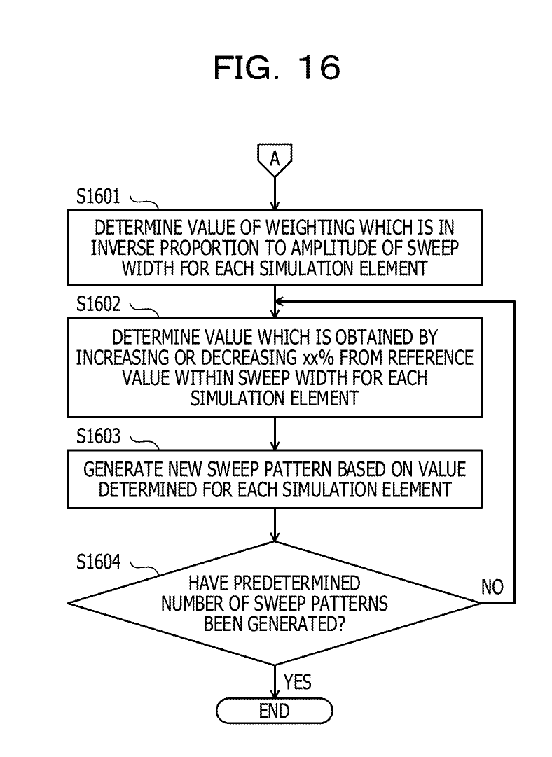

FIG. 15 is a flowchart (I) illustrating an example of a sweep pattern generation processing procedure. Further, FIG. 16 is a flowchart (II) illustrating an example of the sweep pattern generation processing procedure. The sweep pattern generation processing is processing for generating a predetermined number of sweep patterns. The predetermined number may be determined at random by the simulation integration system 200 or may be specified by the user U.

The PC 201 receives inputs of each simulation element which is a variable and a level of importance of each simulation element (step S1501). For example, the PC 201 displays candidates of a level of importance in a table form of a graphical user interface (GUI) for each simulation element. Then, the PC 201 receives the level of importance inputted through an operation of the user U as a level of importance of the simulation element.

Subsequently, the PC 201 receives an input representing which simulation technique each simulation element, which is an input element, corresponds to (step S1502). For example, the PC 201 displays a check box which enables selection of the simulation technique 1a, 1b, or 2, in the table form of the GUI for each simulation element. Then, the PC 201 receives a simulation element which is checked through an operation of the user U as an input element corresponding to a simulation technique.

Then, the PC 201 receives an input representing whether a type of each simulation element is an “analysis object” or a “non-analysis object” (step S1503). For example, the PC 201 displays a pulldown menu which enables selection of an “analysis object” or a “non-analysis object” for a type of each simulation element in the table form of the GUI. Then, the PC 201 receives the selected item as the type of the simulation element.

Subsequently, the PC 201 determines whether or not each simulation element is a common element between a simulation technique 1x and the simulation technique 2 (step S1504). When the table 900 illustrated in FIG. 9 is taken as an example for the processing in step S1504, the simulation elements B and C are elements common to the simulation techniques 1a, 1b, and 2. Accordingly, the PC 201 determines that the simulation elements B and C are common elements.

Subsequently, the PC 201 selects non-selected simulation elements among all simulation elements (step S1505). Then, the PC 201 judges whether the selected simulation element is not a “common element” and is an input element of the simulation technique 1x (step S1506). Here, the simulation technique 1x represents the simulation techniques 1a and 1b.

In the case where the selected simulation element is not a “common element” and is an input element of the simulation technique 1x (step S1506: Yes), the PC 201 determines a sweep width of the selected simulation element based on the type and the level of importance of the selected simulation element (step S1507). Specifically, the PC 201 reduces the sweep width as the level of importance of the selected simulation element is higher. However, even though the level of importance of the selected simulation element is high, the PC 201 increases the sweep width in the case where the type of the selected simulation element is a “non-analysis object”.

On the other hand, in the case where the selected simulation element is a “common element” or is not an input element of the simulation technique 1x (step S1506: No), the PC 201 does not determine a sweep width. This is because in the case where the selected simulation element is a “common element”, the same fixed value is inputted into each simulation technique and accordingly sweeping is not executed. Further, this is because sweeping is not executed in the case where the selected simulation element is not an input element of the simulation technique 1x, that is, where the selected simulation element is a simulation element which is an input element only with respect to the simulation technique 2.

After the end of the processing of step S1507 or in the case of the result of step S1506: No, the PC 201 determines whether or not to have selected all simulation elements (step S1508). In the case where there is a simulation element which has not been selected (step S1508: No), the PC 201 makes a transition to processing of step S1505.

On the other hand, in the case where the PC 201 has selected all simulation elements (step S1508: Yes), the PC 201 determines a value of weighting which is in inverse proportion to amplitude of a sweep width for each simulation element (step S1601). When the table 900 is used as an example for the processing of step S1601, the PC 201 determines weighting of the simulation element A whose sweep width is the smallest, as 20 which is the largest value. Further, the PC 201 determines weighting of the simulation elements F to I whose sweep width is the largest, as 5 which is the smallest value.

Subsequently, the PC 201 determines a value which is obtained by increasing or decreasing xx % from a reference value within a sweep width for each simulation element (step S1602). Then, the PC 201 generates a new sweep pattern based on the value determined for each simulation element (step S1603). Subsequently, the PC 201 determines whether or not to have generated a predetermined number of sweep patterns (step S1604).

In the case where the PC 201 has not generated the predetermined number of sweep patterns (step S1604: No), the PC 201 makes a transition to the processing of step S1602. On the other hand, in the case where the PC 201 has generated the predetermined number of sweep patterns (step S1604: Yes), the PC 201 ends the sweep pattern generation processing.

FIG. 17 is a flowchart illustrating an example of a fitting processing procedure by the simulation technique 2. The simulation server 202 sets a parameter of a simulation environment (step S1701). Subsequently, the simulation server 202 executes the simulation technique 2 by using reference values of the simulation elements B and C as input values (step S1702). Then, the simulation server 202 calculates a pseudo Eye area based on the execution result by using formula (1) to formula (4) below (step S1703).

SIGᵢ=∫ₜ₁^{t2}|Rxᵢ(t)|dt (1)

Here, SIG (signal) denotes an Eye area in an ideal state of an object signal. The ideal state is a state free from a noise influence. Further, Rx denotes a reception signal.

$${FEXT}_{i} = {\sum }_{j \neq i}^{n} \vert {FEXT}_{ij} \vert = {\sum }_{j \neq i}^{n} {\int }_{0}^{tmax} \vert {FEXT}_{ij} ( t ) \vert dt \qquad ( 2 )$$

Here, far end cross talk (FEXT) is one of noises which influence on an object signal and is a noise received from an adjacent signal.

ISIᵢ=∫₀^{t1}|Rxᵢ(t)|dt+∫ₜ₂^{t max}|Rxᵢ(t)|dt (3)

Here, inter-symbol interference (ISI) is one of noises which influence on an object signal and is a noise generated between adjacent data on a single identical signal line.

Pseudo Eye area=SIGᵢ−ISIᵢ−FEXTᵢ (4)

For example, the simulation server 202 calculates a pseudo Eye area as 10.44 as illustrated in the record 1301-1. After the end of the processing of step S1703, the simulation server 202 transmits the calculated pseudo Eye area to the PC 201 and ends the fitting processing by the simulation technique 2.

FIG. 18 is a flowchart (I) illustrating an example of a fitting processing procedure by the simulation techniques 1a and 1b. FIG. 19 is a flowchart (II) illustrating an example of the fitting processing procedure by the simulation techniques 1a and 1b. Here, the simulation technique 1a and the simulation technique 1b are executed by applications different from each other. For example, if the CPU 301 has a plurality of cores, the PC 201 may allow the first core to execute an application for executing the simulation technique 1a and may allow the second core to execute an application for executing the simulation technique 1b.

The PC 201 executes the simulation technique 1a by using reference values of the simulation elements A to C and E to I as input values with an application for executing the simulation technique 1a (step S1801). For example, the PC 201 executes the simulation technique 1a to obtain an actual Eye height 30.6218 [mV] and an actual Eye width 16.3336 [ps] which are execution results, as illustrated in the record 1101-1.

Further, the PC 201 executes the simulation technique 1b by using values identical to the input values in step S1801, that is, by using the reference values of the simulation elements A to C and E to I as input values with an application for executing the simulation technique 1b (step S1802). For example, the PC 201 executes the simulation technique 1b to obtain a pseudo Eye area 16.5442 which is an execution result, as illustrated in the record 1201-0. In order to approximate this value to the value obtained through the processing of step S1703, inputs are changed. The PC 201 selects non-selected sweep patterns among generated sweep patterns (step S1803). Then, the PC 201 executes the simulation technique 1b by using a value of each simulation element of the selected sweep patterns, as an input value (step S1804). In the processing of step S1804, sweep objects are the simulation elements A, E, F, G, H, and I. Subsequently, the PC 201 judges whether or not to have executed the simulation technique 1b with respect to all sweep patterns (step S1805).

In the case where there is a sweep pattern for which the simulation technique 1b has not been executed (step S1805: No), the PC 201 makes a transition to the processing of step S1803. On the other hand, in the case where the PC 201 has executed the simulation technique 1b with respect to all sweep patterns (step S1805: Yes), the PC 201 specifies sweep patterns which have pseudo Eye areas whose difference with respect to a pseudo Eye area which is an execution result of the simulation technique 2 is 1% or smaller, from all sweep patterns (step S1806). For example, in the state of step S1805: Yes, the PC 201 obtains pseudo Eye areas of sweep1 to sweep12 represented by the records 1201-1 to 1201-12. Then, among the pseudo Eye areas of sweep1 to sweep12, sweep patterns whose difference with respect to 10.44 obtained in the processing of step S1703 is 1% or smaller are sweep3, sweep7, and sweep10 which are depicted in the thick frames in FIG. 12.

Subsequently, the PC 201 determines a sweep pattern whose sum of integrated values is smallest, as a fitting optimum value pattern, among the specified sweep patterns (step S1807). For example, the PC 201 specifies sweep7 whose sum of integrated values is smallest among sweep3, sweep7, and sweep10, as a fitting optimum value pattern, as illustrated in FIG. 14. Here, a sum of integrated values has a smaller value as a setting value is closer to a reference value. Accordingly, a sweep pattern whose sum of integrated values is smallest is basically a pattern whose setting value is closest to a reference value. However, a value of weighting is also included in an integrated value, so that there is the case where a sum of integrated values is not smallest even in a pattern whose setting value is closest to a reference value.

After the end of the processing of step S1807, the PC 201 ends the fitting processing by the simulation technique 1b. Here, the PC 201 outputs a setting value of each simulation element of sweep7 and a pseudo Eye area 10.411 to a file or the like.

Meanwhile, the PC 201 fetches a setting value of each simulation element of the fitting optimum value pattern with an application for executing the simulation technique 1a (step S1901). Specifically, the PC 201 fetches a setting value of each simulation element of sweep7.

Subsequently, the PC 201 executes the simulation technique 1a by using the fetched value as an input value (step S1902). Then, the PC 201 acquires an actual Eye height [mV] and an actual Eye width [ps] which are execution results (step S1903). For example, the PC 201 acquires 20.5011 [mV] as an actual Eye height and 8.7204 [ps] as an actual Eye width, as illustrated in the record 1101-2.

Subsequently, the PC 201 converts the actual Eye height [mV] into EHstep by setting 1 mV as 1 step (step S1904). Further, the PC 201 converts the actual Eye width [ps] into EWstep by setting 1 ps as 1 step (step S1905). Here, a step is a unit for spuriously considering physical amounts in different units, which are mV and ps, as identical units. For example, in the processing of step S1904, the PC 201 converts 20.5011 [mV] which is the actual Eye height into 20.5011 [steps]. In a similar manner, in the processing of step S1905, the PC 201 converts 8.7204 [ps] which is the actual Eye width into 8.7204 [steps].

Subsequently, the PC 201 calculates actual Eye area=EHstep×EWstep/2 (step S1906). For example, the PC 201 calculates an actual Eye area as 89.3889. Then, the PC 201 calculates mutual conversion factor a=actual Eye area/pseudo Eye area (step S1907). For example, the PC 201 calculates mutual conversion factor a=89.3889/10.411=8.5860. Here, since calculation methods of an actual Eye area and a pseudo Eye area are different from each other, an actual Eye area and a pseudo Eye are sometimes largely different from each other as described above though the actual Eye area and the pseudo Eye area normally have values identical to each other when input values are identical to each other. After the end of the processing of step S1907, the PC 201 ends the fitting processing by the simulation technique 1a. Here, the PC 201 outputs the mutual conversion factor a to a file or the like.

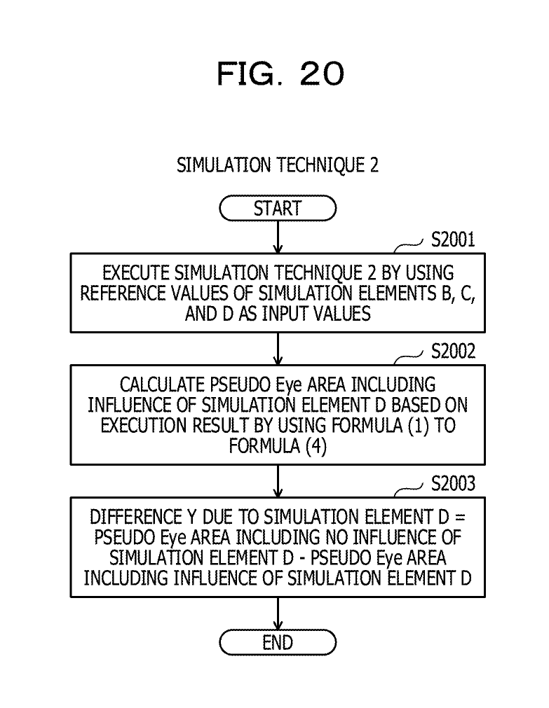

FIG. 20 is a flowchart illustrating an example of a difference calculation processing procedure by the simulation technique 2. The simulation server 202 executes the simulation technique 2 by using reference values of the simulation elements B, C, and D as input values (step S2001). Then, the simulation server 202 calculates a pseudo Eye area including an influence of the simulation element D based on the execution result by using formula (1) to formula (4) mentioned above (step S2002). For example, the simulation server 202 calculates a pseudo Eye area including the influence of the simulation element D as 9.32 as illustrated in the record 1301-2.

Then, the simulation server 202 calculates difference Y due to simulation element D=pseudo Eye area including no influence of simulation element D−pseudo Eye area including influence of simulation element D (step S2003). Here, the pseudo Eye area including no influence of the simulation element D is a value obtained through the processing of step S1703. For example, the simulation server 202 calculates the difference Y as 10.44−9.32=1.12. The difference Y sometimes has a negative value.

After the end of the processing of step S2003, the difference Y is transmitted to the PC 201 and the difference calculation processing by the simulation technique 2 is ended.

FIG. 21 is a flowchart illustrating an example of a factor definition processing procedure. The PC 201 calculates influence degree Z=difference Y×mutual conversion factor a (step S2101). For example, the PC 201 calculates influence degree Z=1.12×8.5860=9.6163.

The influence degree Z is an area difference. It is impossible to identify the influence to each of an Eye height and an Eye width from this influence degree Z. Specifically, the influence degree Z may affect only the Eye height, may affect only the Eye width, or may affect both of the Eye height and the Eye width. Therefore, the PC 201 obtains the minimum Eye height and the minimum Eye width on which Eye becomes minimum, as the worst case.

After the end of the processing of step S2101, the PC 201 calculates EHstep(Min)=(actual Eye area−Z)×2/EWstep (step S2102). Here, EWstep is obtained through the processing of step S1905. For example, the PC 201 calculates EHstep(Min)=(89.3889−9.6163)×2/8.7204=18.2956.

Further, the PC 201 calculates EWstep(Min)=(actual Eye area−Z)×2/EHstep (step S2103). Here, EHstep is obtained through the processing of step S1904. For example, the PC 201 calculates EWstep(Min)=(89.3889−9.6163)×2/20.5011=7.7823.

Then, the PC 201 calculates actual Eye area(Min)=EHstep×EWstep/2 (step S2104). For example, the PC 201 calculates actual Eye area(Min)=18.2956×7.7823/2=71.1909. Subsequently, in order to return the units to mV and ps, the PC 201 converts EHstep(Min) into the minimum Eye height [mV] by setting 1 step as 1 mV (step S2105) and converts EWstep(Min) into the minimum Eye width [ps] by setting 1 step as 1 ps (step S2106). For example, the PC 201 converts the minimum Eye height into 18.2956 [mV] and converts the minimum Eye width into 7.7823 [ps].

Then, in order to define an influence rate of the influence of the simulation element D, the PC 201 calculates Eye height influence rate=(actual Eye height−minimum Eye height)/actual Eye height×100 (step S2107). For example, the PC 201 calculates Eye height influence rate=(20.5011−18.2956)/20.5011×100=10.76[%]. Further, the PC 201 sets Eye width influence rate=(actual Eye width−minimum Eye width)/actual Eye width×100 (step S2108). For example, the PC 201 calculates (8.7204−7.7823)/8.7024×100=10.76[%]. The Eye height influence rate and the Eye width influence rate are the influence rate of the simulation element D. After the end of the processing of step S2108, the PC 201 ends the factor definition processing. Further, the calculation methods of the Eye height influence rate and the Eye width influence rate are not limited to the examples described in the processing of step S2107 and step S2108. For example, a formula obtained by converting each variable on the right side in step S2102 into [mV] may be assigned to “minimum Eye height” in the processing of step S2107.

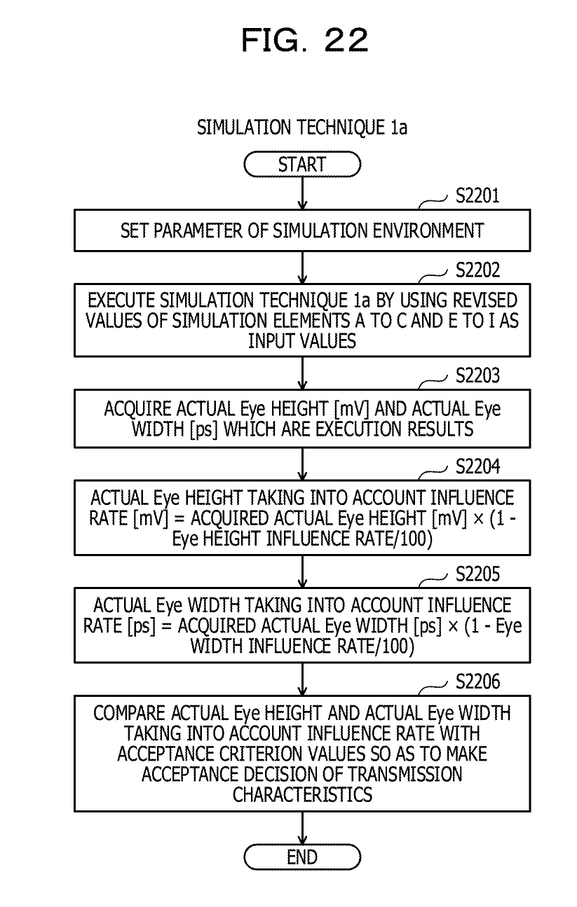

FIG. 22 is a flowchart illustrating an example of an actual simulation processing procedure. The PC 201 sets a parameter of a simulation environment (step S2201). Subsequently, the PC 201 executes the simulation technique 1a by using revised values of the elements A to C and E to I as input values (step S2202). Then, the PC 201 acquires an actual Eye height [mV] and an actual Eye width [ps] which are execution results (step S2203). For example, the PC 201 acquires 26.3303 [mV] as an actual Eye height and 14.1286 [ps] as an actual Eye width, as illustrated in the record 1101-3.

Subsequently, the PC 201 calculates actual Eye height taking into account influence rate [mV]=acquired actual Eye height [mV]×(1−Eye height influence rate/100) (step S2204). For example, the PC 201 calculates actual Eye height taking into account influence rate=26.3303×(1−10.76/100)=23.4972 [mV]. Further, the PC 201 sets actual Eye width taking into account influence rate [ps]=acquired actual Eye width [ps]×(1−Eye width influence rate/100) (step S2205). For example, the PC 201 calculates 14.1286×(1-10.76/100)=12.6084 [ps].

Then, the PC 201 compares the actual Eye height and actual Eye width taking into account the influence rate with acceptance criterion values so as to make an acceptance decision of transmission characteristics (step S2206). If the actual Eye height and the actual Eye width taking into account influence rate exceed the acceptance criterion values when the acceptance criterion value of the Eye height is 15.0 [mV] and the acceptance criterion value of the Eye width is 8.0 [ps] for example, the transmission characteristics is judged acceptable. Since both of the actual Eye height and the actual Eye width taking into account influence rate exceed the acceptance criterion values, the PC 201 judges the transmission characteristics acceptable. After the end of the processing of step S2206, the PC 201 ends the actual simulation processing.

As described above, the PC 201 corrects actual Eye height and width, which are obtained by the simulation technique 1a which does not permit input of the simulation element D, based on a mutual conversion factor obtained by the simulation technique 1b which bridges the simulation techniques 1a and 2. Accordingly, it is possible for the PC 201 to improve accuracy in decision of transmission characteristics because the input value of the element D is taken into account in a correction result. Further, the simulation integration system 200 is capable of performing transmission characteristics analysis including all designing elements, enabling more accurate risk decision and effect confirmation and necessity decision of layout designing change. Accordingly, simulation accuracy before designing completion is enhanced and thus, it is possible for the simulation integration system 200 to reduce revision risk. Further, it is possible to preliminarily confirm an influence of modification with high accuracy even if revision is desired, being able to reduce risk of second revision. Further, in the case where a problem occurs in transmission evaluation of a completed substrate, it is possible to reproduce a phenomenon of the problem and specify the cause of the problem by using the simulation based on this embodiment.

Further, the PC 201 may calculate a mutual conversion factor a based on a determined fitting optimum value pattern and store the calculated mutual conversion factor in the storage unit 110. The mutual conversion factor represents a relationship between an actual Eye area and a pseudo Eye area which is an index identical to the actual Eye area. The PC 201 may obtain an actual Eye area which is influenced by an input value of a certain simulation element by using a mutual conversion factor when a pseudo Eye area which is influenced by the input value of the certain simulation element is obtained.

Further, the PC 201 may determine a fitting optimum value pattern based on a difference between each input value of each sweep pattern and a received first input value. Accordingly, it is possible for the PC 201 to determine a value closer to an input value which is inputted by the user U, as an optimum value pattern.

Further, the first type of index is set as an Eye height and an Eye width, the second type of index is set as an Eye area, and the third type of index is set as a pseudo Eye area in this embodiment, but other indices may be used.

Further, the simulation technique 2 described in this embodiment is simulation in time domain, but the simulation technique 2 is not limited to this. For example, electromagnetic field analysis or frequency analysis may be employed as the simulation technique 2. Even in the electromagnetic field analysis or the frequency analysis, it is possible to obtain a pseudo Eye area by the above-mentioned formulas (1) to (4). Further, the above-described analysis technique is analysis focusing on noise components such as ISI and FEXT, but there are many types of noises other than these, in other analysis techniques. For example, there is analysis called channel noise scan (CNS) focusing on a radiation noise of a power source. This analysis is identical to the above-mentioned analysis technique regarding a main signal, and in this analysis, the level of influence of a focused noise with respect to a main signal is analyzed. Thus, this analysis enables calculation of a pseudo Eye area as well, being able to be employed as the simulation technique 2.

Here, the simulation assist method described in this embodiment may be realized through an execution of a prepared program by a computer such as a personal computer and a workstation. This simulation assist program is recorded in a computer-readable recording medium such as a hard disk, a flexible disk, a compact disc-read only memory (CD-ROM), and a digital versatile disk (DVD) and is read from the recording medium by the computer so as to be executed. Further, this simulation assist program may be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A simulation assist apparatus comprising:
a memory; and
a processor coupled to the memory and configured to:
acquire a first index value being obtained by processing a first element among a plurality of elements included in an analysis object by a first simulation technique,
acquire a second index value based on the first index value,
acquire a third index value being obtained by processing a specific element being not permitted to be processed by the first simulation technique, and the first element among the plurality of elements, by a second simulation technique,
acquire a fourth index value being obtained by processing the first element by the second simulation technique,
calculate an influence degree of the specific element based on a division value being obtained by dividing the second index value by the third index value, and a difference between the third index value and the fourth index value, and
calculate a fifth index value being estimated to be obtained by processing the specific element by the first simulation technique, based on the first index value and the influence degree.

2. The simulation assist apparatus according to claim 1, wherein
the processor
receives a first input value of the first element,
generates a plurality of input values of the first element based on the first input value which is received,
processes each input value of the plurality of input values by a third simulation technique, by which a same element as an element in the first simulation technique is processed and the third index value is outputted, so as to acquire the third index value,
determines a second input value among the plurality of input values based on a difference between the third index value being obtained by processing the first input value by the second simulation technique, and the each value which is acquired, and
divides the second index value based on the first index value, the second index value being obtained by processing the second input value by the first simulation technique, by the third index value being obtained by processing the second input value by the third simulation technique, so as to calculate the division value.

3. The simulation assist apparatus according to claim 2, wherein
the processor determines the second input value among the plurality of input values based on a difference between the third index value being obtained by processing the first input value by the second simulation technique, and the each value and a difference between the each input value and the first input value.

4. The simulation assist apparatus according to claim 1, wherein
the analysis object is a printed circuit board,
the first index is a height and a width of an Eye pattern formed by waveforms of a signal flowing in the analysis object,
the second index is an area of the Eye pattern, and
the third index is a pseudo area of the Eye pattern, the pseudo area being obtained by excluding an influence of a noise from an area of the Eye pattern obtained in an ideal state of the signal.

5. The simulation assist apparatus according to claim 1, wherein
the first simulation technique and the second simulation technique are simulation in time domain.

6. A simulation assist method comprising:
acquiring, by a processor, a first index value being obtained by processing first element among a plurality of elements included in an analysis object by a first simulation technique;
acquiring, by a processor, a second index value based on the first index value;
acquiring, by a processor, a third index value being obtained by processing a specific element being not permitted to be processed by the first simulation technique, and the first element among the plurality of elements, by a second simulation technique;
acquiring, by a processor, a fourth index value being obtained by processing the first element by the second simulation technique;
calculating, by a processor, an influence degree of the specific element based on a division value being obtained by dividing the second index value by the third index value, and a difference between the third index value and the fourth index value; and
calculating, by a processor, a fifth index value being estimated to be obtained by processing the specific element by the first simulation technique, based on the first index value and the influence degree.
